(19) United States
(12) Patent Application Publication
(10) Pub. No.: US 2013/0099790 A1
(43) Pub. Date: Apr. 25, 2013

(54) MULTI-AXIS MARKER LOCATOR

(71) Applicants: Ziyad H. Doany, Austin, TX (US); Timothy A. Parkinson, Austin, TX (US)

(72) Inventors: Ziyad H. Doany, Austin, TX (US); Timothy A. Parkinson, Austin, TX (US)

(73) Assignee: 3M Innovative Properties Company

(21) Appl. No.: 13/278,991

(22) Filed: Oct. 21, 2011

(51) Int. Cl. G01V 3/12; H01Q 21/28

(52) U.S. Cl. 324/326; 343/728

(57) ABSTRACT

A portable locator for locating an obscured marker. The locator includes a portable locator housing, a first antenna disposed within the housing, a second antenna disposed orthogonally to the antenna within the housing; and a processor. The processor is configured to interact with each of the first and second antennas, such that each of the first and second antennas is configured to transmit and receive signals. The locator may include more than two antennas, and may include multiple sets of antennas.

### TECHNICAL FIELD

The present invention relates to locators for locating obscured markers. More specifically, the present invention relates to portable locators with multi-axis antenna arrays.

### BACKGROUND

Various types of markers are used to mark obscured or buried assets all around the world. For example, pipes for water, gas and sewage, and cables for telephone, power and television are buried underground around the world, and it often becomes important to know the precise location of the buried asset or conduit years later. Various types of markers can be attached to, buried with or otherwise associated with these assets or conduits.

Tracer wire has been used to electrically mark the path of an underground conduit. Tracer wire is sometimes buried with the conduit or asset. When one end of the tracer wire is activated with an alternating current (AC) signal, the wire conducts the current that generates an electromagnetic field around the conductor in the shape of concentric cylinders. A separate receiver above ground can detect the magnetic field and thereby determine the path of the tracer wire and thus the corresponding asset.

Passive inductive markers have also been used to mark underground assets. Such markers typically include a wire coil and a capacitor tuned to a specific frequency, located in a protective housing. The inductive marker is then buried near the item to be marked. Inductive markers are activated by generating a magnetic field at the marker resonant frequency into the ground in the area where the marker is expected to be found. The magnetic field couples with the marker, and the inductive marker receives and stores energy from the coupled magnetic field during the transmission cycle. When the transmission cycle ends, the inductive marker re-emits the signal generating its own AC magnetic field at its resonant frequency with an exponentially decaying amplitude. A detecting device above ground detects the AC magnetic field from the marker and alerts the user to the presence of the marker.

Radio frequency identification (RFID) markers or tags include both passive and active markers. RFID markers generally use magnetic fields or radio waves to transfer data from an electronic tag to a reader for the purposes of identifying, locating or tracking an object. A passive RFID tag includes an integrated circuit (IC) and an antenna. The integrated circuit typically stores a unique serial number and data related to the marked object. When the RFID tag antenna is in the presence of a magnetic field transmitted by, for example, an RFID locator/reader, the antenna links the integrated circuit to the locator allowing data transmission. Active RFID tags have a power source, such as battery, in addition to an IC and an antenna which allows for greater read range while the batteries still hold charge.

Magnetomechanical markers can also be used to mark underground assets. Co-pending application Ser. No. 12/888,272 filed on Sep. 22, 2010, describes use of magnetomechanical markers in a variety of configurations to mark underground assets.

Other types of markers can also be used to mark obscured assets, as known in the art.

Each of the types of markers responds to a locating device, or locator, which generates an electromagnetic field burst that couples to the marker which in turn generates its own magnetic field as it dissipates the stored energy. Such a locating device typically includes antennas configured as transmitters, receivers, or transceivers to transmit and receive signals to and from the marker, and a user interface as discussed in further detail below. An improved locator for locating obscured markers would be welcomed.

### SUMMARY

The present disclosure is directed generally to a multi-axis portable locator for locating obscured markers. A multi-axis locator includes more than one antenna disposed on more than one axis. A multi-axis locator consistent with the present disclosure can provide additional benefits, such as allowing detection of a marker signal over a greater physical range. A multi-axis locator also allows use of markers with a variety of orientations relative to the marker to still receive a substantial signal. This can decrease marker installation time, effort and expense for obscured markers. For example, if a marker is being placed in the ground at the time a pipe is being buried, it can be dropped or placed in the ground without regard to its particular orientation. Some obscured markers are designed with multiple antennas at various orientations to allow installation without regard to landing or placement orientation of the marker. A multi-axis antenna locator consistent with the present application provides the additional advantage of detecting markers without regard to orientation of the marker, without the marker requiring a multi-axis antenna.

The present disclosure includes, in one embodiment, a portable locator for locating an obscured marker. The locator includes a portable locator housing, a first antenna disposed within the housing, a second antenna disposed orthogonally to the antenna within the housing; and a processor. The processor is configured to interact with each of the first and second antennas, such that at least one of the first and second antennas is configured to transmit and receive signals.

The present disclosure further includes a method of locating obscured markers underground. The method includes providing a portable locator, wherein the locator comprises a first antenna and a second antenna, and wherein the first and second antennas are orthogonal to each other. The method further includes transmitting a signal from one of the first or second antennas; and receiving a signal from a marker by at least one of the first and second antennas. It then includes processing the received signals to create a cumulative received signal.

The present disclosure also includes a portable locator for locating an obscured marker. The portable locator includes a portable locator housing and a first set of antennas disposed within the housing, the first set of antennas comprising at least two antennas disposed orthogonally with respect to each other. The portable locator also includes a second set of antennas disposed within the housing, the second set of antennas comprising at least two antennas disposed orthogonally with respect to each other. The portable locator includes a processor, wherein the processor is configured to interact with each of the first and second sets of antennas, such that at least one of the first and second sets of antennas is configured to transmit and receive signals.

### BRIEF DESCRIPTION OF THE DRAWINGS

The invention may be more completely understood in consideration of the following detailed description of various embodiments of the invention in connection with the accompanying drawings, in which:

FIG. 1 shows a portable locator for locating obscured markers.

FIG. 2 shows a portable locator having two orthogonal antennas.

FIG. 3 shows a portable locator having three orthogonal antennas.

FIG. 4A shows a front view of a configuration for three orthogonal antennas.

FIG. 4B shows a perspective view of a configuration for three orthogonal antennas.

FIG. 5 shows a schematic representation of a dual set of orthogonal antennas as could be used in a portable locator.

FIG. 6A shows an exemplary positioning of portable locator antennas with respect to a marker antenna where one of the locator antennas is aligned with the marker antenna.

FIG. 6B shows an exemplary positioning of portable locator antennas with respect to a marker antenna where none of the locator antennas is aligned with the marker antenna.

FIG. 6C shows an exemplary positioning of portable locator antennas with respect to a marker antenna where the portable locator antennas are offset from the marker antenna.

FIG. 7 shows simulated responses of a single-axis marker with a vertically oriented antenna to a signal transmitted and received by a locator with a vertically oriented antenna, and a cumulative received signal transmitted and received by vertically and horizontally oriented antennas in a dual-axis antenna array.

FIG. 8 shows simulated responses of a single-axis marker with a vertically oriented antenna to a signal transmitted and received by a single-axis locator with a horizontally oriented antenna, and a cumulative received signal transmitted and received by vertically and horizontally oriented antennas in a dual-axis antenna array.

FIG. 9 shows a simulated response of a single-axis marker with a horizontally oriented antenna to a signal transmitted and received by a single-axis locator with a vertically oriented transmit antenna, and a cumulative received signal transmitted and received by vertically and horizontally oriented antennas in a dual-axis antenna array.

FIG. 10 shows a simulated response of a single-axis marker with a horizontally oriented antenna to a signal transmitted and received by a single-axis locator with a horizontally oriented transmit antenna, and a cumulative received signal transmitted and received by vertically and horizontally oriented antennas in a dual-axis antenna array.

The accompanying drawings are shown to illustrate various embodiments of the present invention. It is to be understood that the embodiments may be utilized, and structural changes may be made, without departing from the scope of the present invention. The figures are not necessarily to scale. Like numbers used in the figures generally refer to like components. However, it will be understood that the use of a number to refer to a component in a given figure is not intended to limit the component in another figure labeled with the same number.

### DETAILED DESCRIPTION

The present disclosure relates to a multi-axis locator for locating obscured markers. Such a multi-axis locator can result in improved detected signal strength by the locator and can reduce labor involved in placing markers, or even the cost of markers required to achieve improved locating performance.

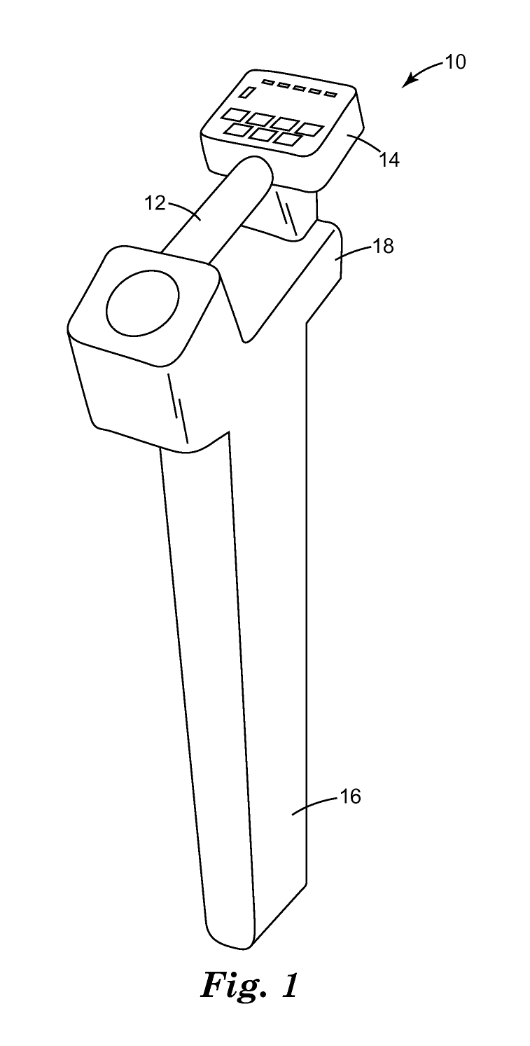

FIG. 1 shows an exemplary portable locator 10 for locating obscured markers. Locator 10 includes handle 12 to allow a user to carry locator 10 while searching for obscured markers. User interface 14 can provide feedback to a user. User interface 14 may include a display, buttons, a keyboard, or other features by which a user can input information into and receive information from locator 10. In some embodiments, user interface may also include a touch-sensitive display. Portable locator 10 can include a computer (not shown) with a processor and memory for processing information received from signals received from an antenna, and storing such information or other relevant information.

Antenna portion 16 of locator 10 can include multiple antennas as consistent with the present disclosure. A variety of antenna types may be used consistent with the present application. For example, an antenna may be a dipole antenna, such as one wrapped about a ferrite core, it may be disposed on a printed circuit board, or arranged in any other appropriate configuration.

Housing 18 encloses the various components of portable locator 10. Additionally, housing 18 may be configured so that additional components can be attached to portable locator 10. In some embodiments, housing 18 may be arranged to allow attachment of a portable computer to locator 10. In some embodiments other components may be able to be attached to housing 18, or antenna portion 16 may be modular such that it is interchangeable.

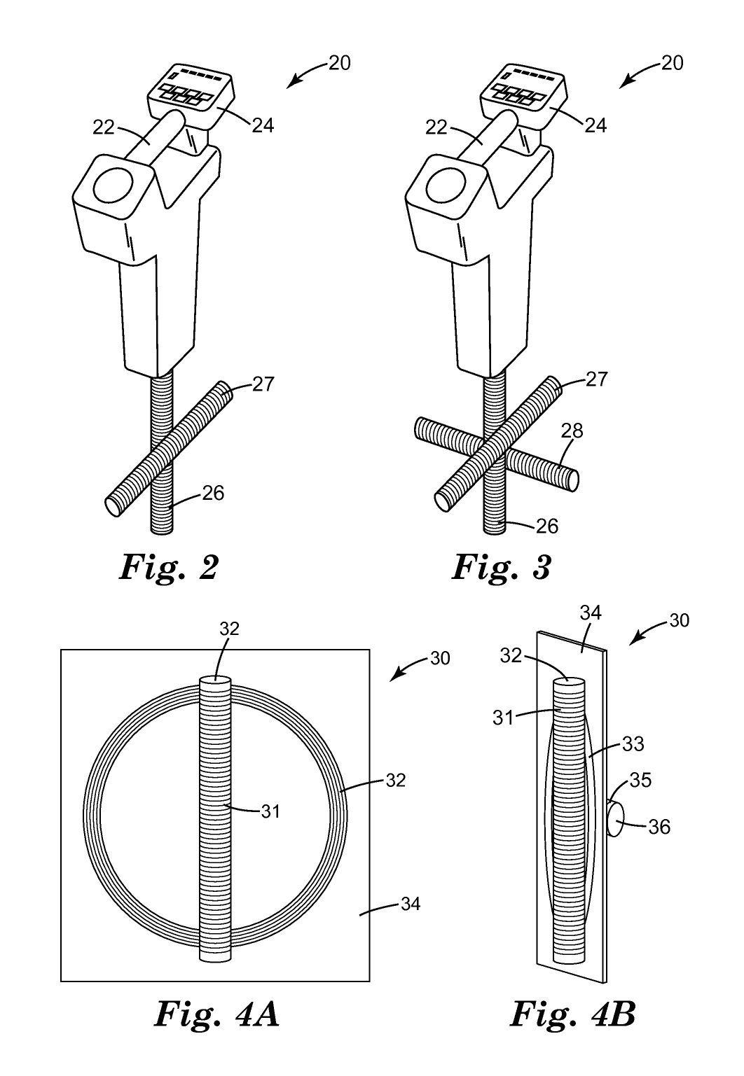

FIG. 2 shows a portable locator 20 having two orthogonal antennas. A locator 20 having two antennas may be referred to as having a dual-axis antenna array, and is a type of a multi-axis antenna locator. While the antennas 26, 27 in FIG. 2 are orthogonal, antennas may be configured in any appropriate arrangement with respect to each other. They may or may not intersect, and additionally, antennas 26, 27 may also be disposed at an acute or obtuse angle with respect to each other.

In some embodiments, portable locator 20 can include a handle 22. In other embodiments, portable locator 20 may instead or additionally include other mechanisms to enable portability, for example, wheels, a clip which can be attached to a belt, or a mounting mechanism to attach the locator 20 to a moving vehicle or other machinery. User interface 24 allows a user to receive information from and/or input information into portable locator 20. As discussed above, portable locator 20 may also include other components, such as a computer, a housing, a display or other features known in the art.

FIG. 2 shows a portable locator 20 with an exemplary set of orthogonal antennas. In one embodiment, first antenna 26 and second antenna 27 may be enclosed within a housing. Alternatively, first antenna 26 and second antenna 27 may be attachable to a housing or the main body of portable locator 20. Antennas in a locator can be configured for multiple purposes in a variety of ways. For example, an antenna may be designed so that, when a user activates the portable locator, the antenna transmits a radio frequency signal, at a particular frequency, thereby generating an electromagnetic field in the vicinity of the antenna. The orientation of a transmitting antenna determines the orientation of the magnetic field. When a magnetic field generated by an antenna is properly oriented relative to dipole marker, the magnetic field interaction with the marker is optimized.

An antenna can be configured to only transmit, only receive, or both transmit and receive signals. Such an antenna is often referred to as a transceiver. Consistent with the present disclosure, first antenna 26 may include two antennas, where one antenna is dedicated to transmitting signals and a second antenna is dedicated to receiving signals. Similarly, second antenna 27 may include two antennas, where one antenna is dedicated to transmitting signals and a second antenna is dedicated to receiving signals.

First antenna 26 and second antenna 27 may be coupled to a processor such that the processor is configured to interact with each of the first 26 and second 27 antennas, such that each of the first 26 and second 27 antennas is configured to transmit and receive signals. In one embodiment, the processor may control first 26 and second 27 antenna so that when first antenna 26 transmits a signal, a backscattered signal from a marker may be received by either or both first 26 and second 27 antennas. Similarly, the processor may control the antennas such that when second antenna 27 transmits a signal, a backscattered signal from a marker may be received by either or both of first 26 and second 27 antenna. The processor may be configured so that a signal is alternately transmitted by first antenna 26, then by second antenna 27, but received in both variations by a one of first 26 and second 27 antennas, or by both first 26 and second 27 antenna. The signals received by both first 26 and second 27 antennas can be processed by the processor with a variety of algorithms. In one algorithm, the processor may compute the root mean square (RMS) of the signals received by first antenna 26 and second antenna 27 respectively, for each of the transmitted directions, to create a cumulative signal used in locating an obscured marker. When using a cumulative signal, the location of the marker corresponds to the point where the cumulative signal has the greatest magnitude.

FIG. 3 shows a portable locator 20 having three orthogonal antennas. In this configuration, when compared to FIG. 2, portable locator includes a third antenna 28 configured to be orthogonal to first antenna 26 and second antenna 27. Third antenna 28 can be configured to operate similarly to first 26 and second 27 antennas as described herein. For example, when first antenna 26 transmits a signal, each of first 26, second 27 and third 28 antennas can be configured to receive the backscattered signal from a marker within range of the portable locator 20. The processor may be configured to cause first 26, second 27 and third 28 antennas to transmit signals alternately, rotating through the three antennas, where each antenna may receive response signals when any antenna is transmitting. In the particular illustration of FIG. 3, second 27 and third 28 antennas are oriented orthogonally with respect to each other, but are both oriented horizontally. First antenna 26 is oriented vertically and orthogonally with respect to second 27 and third 28 antennas. The impact of the orientation of antennas within the portable locator 20 relative to an antenna in a marker is discussed in greater detail with respect to Example 1.

While FIGS. 2 and 3 show schematic depictions of first 26, second 27 and third 28 antennas, these are purely schematic depictions to demonstrate the orthogonal configurations of first 26, second 27 and third 28 antennas. First 26, second 27 and third 28 antennas may be any appropriate type of antenna, not just a dipole antenna as illustrated in schematic FIGS. 2 and 3. For example, the antennas may be low frequency induction antennas for transmitting or receiving consist of either an air loop coil antenna or a ferrite rod with windings along its length. Both give a dipole shape magnetic field in the shape of a donut, as will be understood by one of skill in the art. Electromagnetic fields created by various antennas are explained in greater detail in articles and textbooks, such as Section 6.5 of Electricity and Magnetism (Berkeley Physics Course), Volume 2, (1986) by Edward Purcell, 1986.

FIG. 4A shows a front view of a configuration 30 for orthogonal antennas. As mentioned elsewhere, first antenna 31 and second antenna 33 can be configured in a variety of ways. For example, in the antenna configuration shown in FIG. 4A, first antenna 31 is disposed about a ferrite core 32. Second antenna 33 is a coil disposed on a printed circuit board (PCB) as shown. In this particular configuration, third antenna 35 is not visible from this perspective as it may be disposed on the side of the PCB opposite first antenna 31. In some embodiments, there may be only first 31 and second 33 antennas. In some embodiments, third antenna 35 can be configured to be disposed about a second ferrite core 36, similar to first antenna 31.

FIG. 4B shows a perspective view of a configuration 30 for three orthogonal antennas. In the configuration as shown, first antenna 31 is disposed around ferrite core 32. Second antenna 33 is disposed on PCB 34. Third antenna 35 is likewise disposed about ferrite core 36. Each of the antennas 31, 33, 35, is arranged so that they are orthogonal to the other antennas. In other configurations, antennas may be mounted or disposed differently. For example, an antenna array can be rotated while maintaining orthogonality between antennas to optimize the shape and magnitude of the signal received from a marker when the locator is swept over the surface.

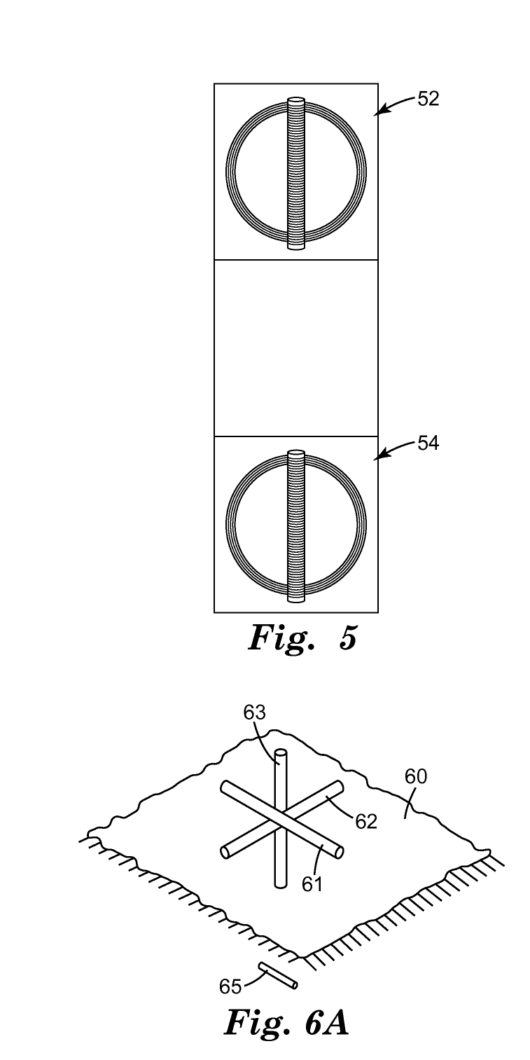

FIG. 5 shows a schematic representation of a dual set of orthogonal antennas as could be used in a portable locator. In some configurations consistent with the present disclosure, a portable locator may include two sets of antennas. A first set of antennas 52 may be disposed within a housing for the portable locator, or in any other appropriate configuration. The first set of antennas 52 may include at least two antennas disposed orthogonally to each other. A second set of antennas 54 may also be disposed within a housing or in another appropriate configuration. The second set of antennas 54 may include two or more antennas disposed orthogonally with respect to each other. Either first 52 or second 54 set of antennas may have any appropriate number and configuration of antennas as would be apparent to one of skill in the art upon reading this disclosure. First 52 and second 54 sets of antennas may be used in conjunction with a processor or computer such that the processor is configured to enable each of the first 52 and second 54 sets of antennas to transmit and receive signals.

In one embodiment, a portable locator consistent with the present disclosure may include first 52 and second 54 sets of antennas to enable the processor to eliminate noise received by the antenna or to allow the processor to estimate a depth of an obscured marker. In areas of high ambient RF noise, the detection range may be greatly reduced. In order to cancel far fields, which are largely uniform over a small area and in the same direction, a second matching receive coil can be placed above the receive coil closer to the marker and connected to subtract from the lower receive antenna. Since the signal from a marker falls rapidly with distance, the signal at the receiver coil further from the marker is substantially less than the received signal from the receive antenna closer to the marker. Therefore, the far field signal cancels while the marker signal received is only slightly reduced, improving the net signal to noise ratio (SNR) of the marker signal. Also, since the signal reduction over distance from a marker is known, the ability to measure the received signal at more than one known antenna position allows the calculation of the estimated location or depth of a marker.

While multiple embodiments consistent with the present disclosure are discussed above, it will be apparent to one of skill in the art upon reading the present disclosure that the features of one embodiment may be combined with or applied to features of another embodiment. For example, in some embodiments, three orthogonal antennas may be used in the place of two. Portable locators consistent with the present disclosure may be handheld, portable due to wheels or some other mechanism. Portable locators consistent with the present disclosure may be used to locate a variety of markers, including RFID, magnetomechanical and other markers.

### Example 1

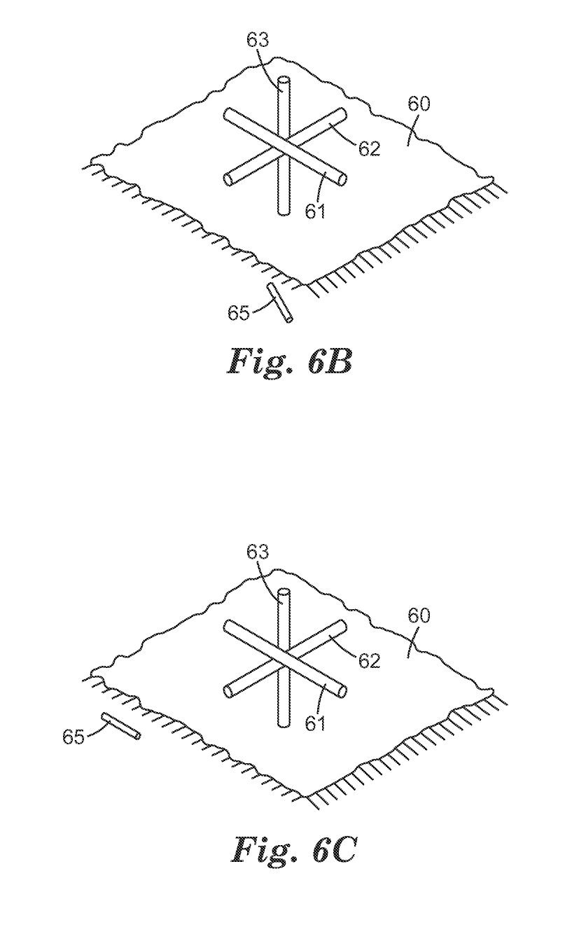

Example 1 is a prophetic example describing the interactions between a portable locator with a three-axis antenna when the antenna is positioned in a variety of configurations with respect to an obscured marker. FIGS. 6A-6C illustrate various orientations and locations of a multi-axis locator with respect to an obscured marker.

FIG. 6A shows a positioning of portable locator multi-axis antenna 61, 62, 63 array with respect to a marker antenna 65 where the first locator antenna 61 is aligned with the marker antenna 65. The locator antenna 61, 62, 63 array is positioned directly over the marker antenna 65. Here, marker antenna 65 is buried beneath ground level 60. A configuration as shown may be encountered when an individual is using a portable locator to search for a buried marker. If a portable locator with a configuration as shown in the earlier figures is used, the locator can be swept above ground level, and at a point in time may be positioned directly above a buried marker. FIG. 6A assumes the case where the orientation of a first antenna 61 is further aligned with the orientation of the marker antenna 65.

In the case shown in FIG. 6A, only the first antenna 61 will couple with the marker antenna 65. Second antenna 62 and third antenna 63 are both directly centered over the marker and oriented orthogonally to marker antenna 65. As such, the electromagnetic field generated by each of the second 62 and third 63 antennas will cancel out, thus not coupling with marker antenna 65. In FIG. 6A, the portable locator will have the performance of a single-axis locator with an antenna in the location of the first antenna 61.

FIG. 6B shows a positioning of portable locator antenna 61, 62, 63 array with respect to a marker antenna 65 where the locator is positioned directly over marker antenna 65, but neither first antenna 61 nor second antenna 62 of the locator is orthogonal to marker antenna 65. This case is more likely to occur when an individual is using a portable locator to search for a buried marker than the case illustrated in FIG. 6A. This is because it is improbable that either first antenna 61 or second antenna 62 will align precisely with the orientation of marker antenna 65. In the case shown in FIG. 6B, the first 61 and the second 62 antennas will couple with the marker antenna 65. However, third antenna 63 will not couple with marker antenna 65 as it is positioned directly over marker antenna 65 and orthogonal to it.

The net signal received in marker antenna 65 from one of first antenna 61 or second antenna 62 is equal to the cosine of the angle (α) between the marker antenna 65 and one of first antenna 61 or second antenna 62 multiplied by the magnitude of the signal (A) as shown below:

S=A*k*cos(α)

where k is the signal coupling coefficient between receiver and marker, and assumed to be equal to 1 for illustration.

The backscattered return signal then received from marker antenna 65 by the portable locator antenna 61 (or 62) originally transmitting the signal is equal to the cosine of the angle (α) between the marker antenna 65 and the portable locator antenna 61 (or 62) squared multiplied by the magnitude of the signal (A) as shown below:

T₆₁RS₆₁=A*cos²(α), transmit with antenna 61, receive with antenna 61

T₆₁RS₆₂=A*cos(α)*sin(α), transmit with antenna 61, receive with antenna 62

T₆₂RS₆₂=A*cos²(π/2−α), transmit with antenna 62, receive with antenna 62

T₆₂RS₆₁=A*cos(π/2−α)*sin(π/2−α), transmit with antenna 62, receive with antenna 61

However, when each of first antenna 61 and second antenna 62 are used to transmit sequentially, and the backscattered return signal from the marker antenna 65 detected by both antennas 61 and 62, the cumulative return signal (CRS) consisting of the sum of the squares of the signal received by all antennas is given below:

CRS=sqrt[T₆₁RS₆₁²+T₆₁RS₆₂²+T₆₂RS₆₂²+T₆₂RS₆₁²]

CRS=A*sqrt[cos⁴(α)+2*cos²(α)sin²(α)+sin⁴(π/2−α)]

CRS=A*sqrt[cos²(α)+sin²(α)]²

CRS=A

This shows that the combined signal is not affected by the rotation angle and is equal to the signal from a perfectly aligned horizontal antenna with the marker. The coupling factor is a function of the distance between the marker and locator antennas, and the marker axis orientation.

FIG. 6C shows a positioning of portable locator antenna 61, 62, 63 array with respect to a marker antenna 65 where the locator is not positioned directly over marker antenna 65, and first antenna 61 is positioned so that it is aligned with marker antenna 65. In this situation, each of first antenna 61, second antenna 62 and third antenna 63 will couple with the antenna marker 65. However, as the portable locator is located further away from the marker antenna 65 the magnitude of the signal received by antenna marker 65 will be less than if the portable locator were disposed directly above the marker antenna 65.

### Example 2

Example 2 illustrates simulated responses of a single-axis marker to a dual-axis antenna array portable locator where the marker antenna and portable locator antennas have a variety of orientations.

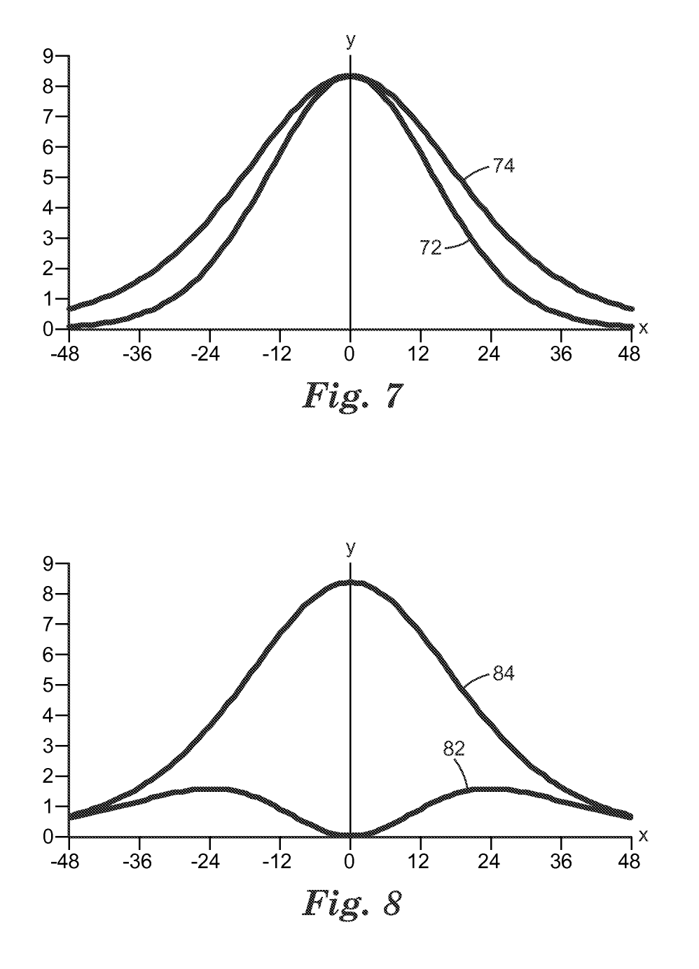

For each simulated locator to marker orientation, the signal response modeling set forth in FIGS. 7 through 10 below, depicts graphically first the signal received by a single-axis antenna locator with a locator antenna in the listed orientation relative to the marker antenna and second, the cumulative received signal by a locator with two antennas, wherein the two antennas are orthogonal, and one of the antennas is in the same orientation as the antenna of the single antenna locator. For the cumulative received signal, both antennas are transmitting and receiving signals. For each simulation, the modeling occurs along an axis intercepting the marker wherein the locator is directly over the marker at the locator horizontal position of zero.

FIG. 7 shows simulated responses of a single-axis marker with a vertically oriented antenna to a signal transmitted and received by a locator with a vertically oriented antenna, and a cumulative received signal transmitted and received by vertically and horizontally oriented antennas in a dual-axis antenna array. The cumulative response shown consists of the RMS value of all four received signal levels.

Shown in FIG. 7 as line 72 is the relative received signal strength received by a locator with a single-axis vertically oriented transmit and receive antenna and with the antenna of the marker vertically oriented. Line 74 depicts the relative received signal strength received by a locator with two antennas, one antenna vertical and the second antenna horizontal. For this simulation, the dual antenna locator transmitted along both the vertical and horizontal antennas, and received by both the vertical and horizontal antennas. Lines 72 and 74 shows that both locators obtain the same relative signal strength at the zero position as expected as at that position when only the vertical antenna of the locator is receiving signal from the vertical marker antenna. As shown by FIG. 7, the dual antenna locator obtains a higher relative received signal strength—line 74—over that of the single antenna location—line 72—at any position other than the zero horizontal position and further, that the dual antenna locator is able to read signal from the marker at a greater distance than the single antenna locator.

FIG. 8 shows simulated responses of a single-axis marker with a vertically oriented antenna to a signal transmitted and received by a single-axis locator with a horizontally oriented antenna, and a cumulative received signal transmitted and received by vertically and horizontally oriented antennas in a dual-axis antenna array. The cumulative response shown consists of the RMS value of all four received signal levels.

Shown in FIG. 8 as line 82 is the relative received signal strength received by a locator with a single-axis horizontally oriented transmit and receive antenna and with the antenna of the marker vertically oriented. Line 84 depicts the relative received signal strength received by a locator with two antennas, one antenna vertical and the second antenna horizontal. For this simulation, the dual antenna locator transmitted along the vertical and horizontal antennas, and received by both the vertical and horizontal antennas. Lines 82 and 84 shows that both locators obtain the same relative signal strength at a position of 48 inches away from the marker as expected as by that distance, only the horizontal antenna of each locator is receiving signal. As shown by FIG. 8, the dual antenna locator obtains a higher relative received signal strength at all positions nearer to the marker than the single antenna locator as the dual antenna locator is transmitting and receiving a cumulative signal along both the vertical and horizontal antennas. As expected, the dual antenna locator is obtaining strong signal from the marker at the zero horizontal position as the vertical antenna is at the maximum B field flux for the configuration of vertical marker antenna and locator horizontal antenna transmission, whereas the single antenna locator is receiving no signal from the vertically oriented marker antenna as the horizontal antenna of the single-axis antenna locator at the zero horizontal position is at a zero B field flux for the configuration of vertical marker antenna and locator horizontal transmit antenna.

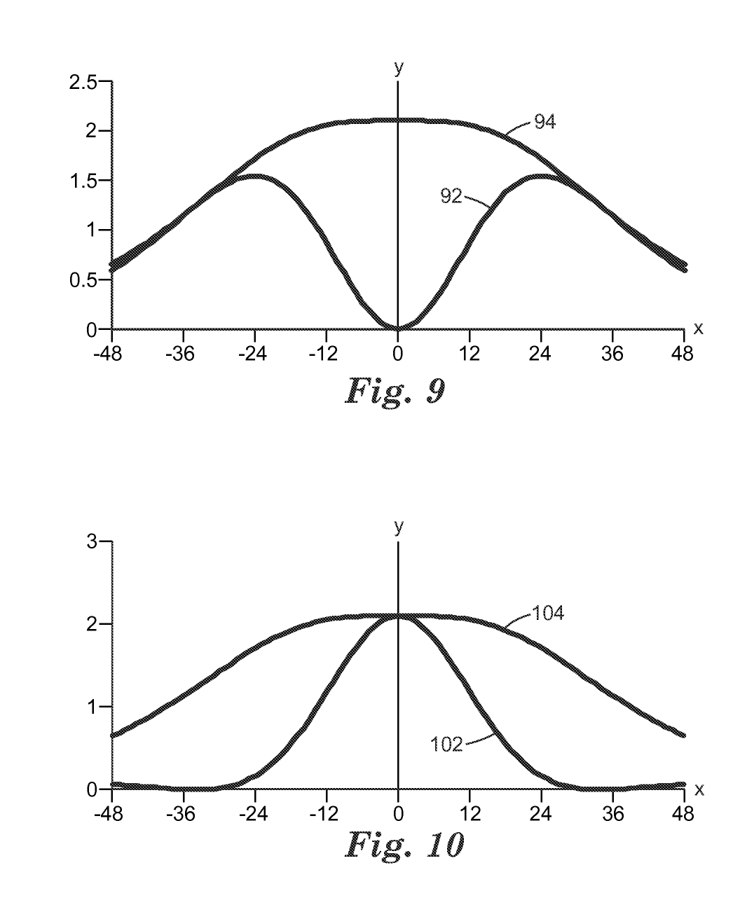

FIG. 9 shows a simulated response of a single-axis marker with a horizontally oriented antenna to a signal transmitted and received by a single-axis locator with a vertically oriented transmit antenna, and a cumulative received signal transmitted and received by vertically and horizontally oriented antennas in a dual-axis antenna array. The cumulative response shown consists of the RMS value of all four received signal levels.

Shown in FIG. 9 as line 92 is the relative received signal strength received by a locator with a single-axis vertically oriented transmit and receive antenna and with the antenna of the marker horizontally oriented. Line 94 depicts the relative received signal strength received by a locator with two antennas, one antenna vertical and the second antenna horizontal, with the marker antenna in the same horizontal orientation. For this simulation, the dual-axis antenna locator transmitted along each the vertical and horizontal axes, and received by both the vertical and horizontal antennas and generating a cumulative RMS receive response. Lines 92 and 94 shows that both locators obtain the same relative signal strength at a position of 30 inches further away from the marker as expected as at that distance and further, the vertical antenna of each locator is receiving the dominant signal, i.e., in B field flux in the orientation of a horizontal marker and vertical transmit antenna. As shown by FIG. 9, the dual antenna locator obtains a higher relative received signal strength at all positions nearer to the marker than the single-axis antenna locator as the dual-axis antenna locator is receiving a cumulative signal along both the vertical and horizontal antennas. As expected, the dual antenna locator is obtaining strong signal from the marker at the zero horizontal position as the horizontal locator antenna is at the maximum B field flux for the configuration of horizontal marker antenna and locator vertical antenna transmission, whereas the single antenna locator is receiving no signal from the horizontally oriented marker antenna as the vertical antenna of the single-axis antenna locator at the zero horizontal position is at a zero B field flux for the configuration of horizontal marker antenna and locator vertical transmit/receive antenna.

FIG. 10 shows a simulated response of a single-axis marker with a horizontally oriented antenna to a signal transmitted and received by a single-axis locator with a horizontally oriented transmit antenna, and a cumulative received signal transmitted and received by vertically and horizontally oriented antennas in a dual-axis antenna array. The cumulative response shown consists of the RMS value of all four received signal levels.

Shown in FIG. 10 as line 102 is the relative received signal strength received by a single-axis locator with a horizontally oriented transmit and receive antenna and with the antenna of the marker horizontally oriented. Line 104 depicts the relative received signal strength received by a locator with two antennas, one antenna vertical and the second antenna horizontal, with the marker antenna in the same horizontal orientation. For this simulation, the dual-axis antenna locator transmitted along each the vertical and horizontal axes, and received by both the vertical and horizontal antennas and generating a cumulative RMS receive response. Lines 102 and 104 shows that both locators obtain the same relative signal strength at the zero position as expected as at that position only the horizontal antenna of each locator is receiving signal. As shown by FIG. 10, the dual-axis antenna locator obtains a higher relative received signal strength—line 104—over that of the single antenna location—line 102—at any position other than the zero horizontal position and further, that the dual antenna locator is able to detect the signal from the marker at a greater distance than the single-axis locator.

Positional terms used throughout the disclosure, e.g., over, under, above, etc., are intended to provide relative positional information; however, they are not intended to require adjacent disposition or to be limiting in any other manner. For example, when a layers or structure is said to be “disposed over” another layer or structure, this phrase is not intended to be limiting on the order in which the layers or structures are assembled but simply indicates the relative spatial relationship of the layers or structures being referred to. Furthermore, all numerical limitations shall be deemed to be modified by the term “about.”

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A portable locator for locating an obscured marker, the locator comprising:
a portable locator housing;
a first antenna disposed within the housing;
a second antenna disposed orthogonally to the antenna within the housing; and
a processor, wherein the processor is configured to interact with each of the first and second antennas, such that at least one of the first and second antennas is configured to transmit and receive signals.

2. The locator of claim 1, further comprising a third antenna, wherein the third antenna is orthogonal to the first antenna and the second antenna.

3. The locator of claim 1, wherein the locator is handheld.

4. The locator of claim 2, wherein the first antenna comprises a coil disposed around a ferrite rod.

5. The locator of claim 4, wherein the second antenna comprises an air coil disposed on a printed circuit board (PCB) or a wire coil.

6. The locator of claim 5, wherein the third antenna comprises a coil disposed around a ferrite rod.

7. The locator of claim 6, wherein the first antenna is disposed on a first side of the PCB and wherein the third antenna is disposed on a second side of the PCB, wherein the first side is opposite the second side.

8. The locator of claim 1, wherein the locator is configured to locate obscured radio frequency identification (RFID) markers.

9. A method of locating obscured markers underground, the method comprising:
(a) providing a portable locator, wherein the locator comprises a first antenna and a second antenna, and wherein the first and second antennas are orthogonal to each other;
(b) transmitting a signal from one of the first or second antennas;
(c) receiving a signal from a marker by at least one of the first and second antennas;
(d) processing the received signals to create a cumulative received signal.

10. The method of claim 9, wherein the portable locator further comprises a third antenna, wherein the third antenna is orthogonal to the first antenna and the second antenna.

11. The method of claim 9, wherein the locator is handheld.

12. The method of claim 9, wherein the received cumulative signal is the root mean square (RMS) of the received signals.

13. The method of claim 9, further comprising providing an indication to a user of a direction of the marker.

14. The method of claim 9, further comprising providing an auditory or a visual indication to a user of the proximity of the marker.

15. A portable locator for locating an obscured marker comprising:
a portable locator housing;
a first set of antennas disposed within the housing, the first set of antennas comprising at least two antennas disposed orthogonally with respect to each other;
a second set of antennas disposed within the housing, the second set of antennas comprising at least two antennas disposed orthogonally with respect to each other;
a processor, wherein the processor is configured to interact with each of the first and second sets of antennas, such that at least one of the first and second sets of antennas is configured to transmit and receive signals.

16. The locator of claim 15, wherein the processor is configured to process signals received by each of the first and second set of antennas from a marker to create a cumulative received.

17. The locator of claim 15, wherein the processor is configured to process signals from each of the first and second set of antennas to estimate a depth of a marker.

18. The locator of claim 15, wherein the locator is configured to locate a RFID marker.

19. The locator of claim 15, wherein the locator is handheld.

20. The locator of claim 15, wherein the first and second set of antennas are physically separated.
